(19) United States
(12) Patent Application Publication
(10) Pub. No.: US 2023/0054215 A1
(43) Pub. Date: Feb. 23, 2023

(54) ABNORMALITY ESTIMATION APPARATUS, ABNORMALITY ESTIMATION METHOD, AND COMPUTER-READABLE RECORDING MEDIUM

(71) Applicant: NEC Corporation, Minato-ku, Tokyo (JP)

(72) Inventors: Sakiko Mishima, Tokyo (JP); Shigeru Kasai, Tokyo (JP); Shohei Kinoshita, Tokyo (JP)

(73) Assignee: NEC Corporation, Minato-ku, Tokyo (JP)

(21) Appl. No.: 17/797,288

(22) PCT Filed: Feb. 19, 2020
(86) PCT No.: PCT/JP2020/006573

§ 371 Date: Aug. 3, 2022

(51) Int. Cl. G01M 5/00

(52) U.S. Cl. CPC G01M 5/0066; G01M 5/0008

(57) ABSTRACT

An abnormality estimation apparatus 10 includes: a detection unit 11 configured to detect a vibration response when a vehicle passes over an expansion and contraction apparatus 23, using vibration information indicating vibration that occurs in a bridge; a first index calculation unit 12 configured to calculate a first index for determining the presence or absence of an abnormality in the expansion and contraction apparatus 23, using the vibration response; and an estimation unit 13 configured to estimate the presence or absence of an abnormality in accordance with a change in the first index.

### TECHNICAL FIELD

The invention relates to an abnormality estimation apparatus and an abnormality estimation method for estimating the presence or absence of an abnormality in an expansion and contraction apparatus, and in particular relates to a computer-readable recording medium on which a program for realizing the apparatus and method is recorded.

### BACKGROUND ART

Under current circumstances, a degradation diagnosis of an expansion and contraction apparatus for absorbing expansion and contraction of a bridge, the apparatus being installed between bridge beams, is performed manually, for example, through close visual observation and hammering. In view of this, techniques for automatically performing a degradation diagnosis of an expansion and contraction apparatus have been disclosed.

Patent document 1 discloses a degradation diagnosis method for determining the degree of degradation of an expansion and contraction apparatus as a related technique. In the degradation diagnosis method disclosed in Patent document 1, a plurality of microphones are installed on a road shoulder to obtain sound pressure waveform data of sound produced by a vibrating expansion and contraction apparatus. Next, a peak ratio R = (PH/PL) is calculated using a reference peak value PL and a high-pass peak value PH, based on a frequency spectrum obtained through Fourier analysis. The degree of degradation of the expansion and contraction apparatus is then determined using this peak ratio R.

### LIST OF RELATED ART DOCUMENTS

### Patent Document

Patent document 1: Japanese Patent Laid-Open Publication No. 2016-191640

### SUMMARY OF INVENTION

### Technical Problems

However, in the degradation diagnosis method of Patent document 1, environmental noise is collected along with sound produced by the expansion and contraction apparatus, and thus the accuracy for determining the degree of degradation of the expansion and contraction apparatus is reduced. Furthermore, in the degradation diagnosis method of Patent document 1, there is a need to install microphones on a road or a road shoulder in the vicinity of the expansion and contraction apparatus, which requires traffic lane regulations.

An example object of the invention is to provide an abnormality estimation apparatus, an abnormality estimation method, and a computer-readable recording medium for improving the accuracy for estimating the presence or absence of an abnormality in an expansion and contraction apparatus.

### Solution to the Problems

In order to achieve the example object described above, an abnormality estimation apparatus according to an example aspect of the invention includes:
a detection unit configured to detect a vibration response when a vehicle passes over an expansion and contraction apparatus, using vibration information indicating vibration that occurs in a bridge;
a first index calculation unit configured to calculate a first index for determining the presence or absence of an abnormality in the expansion and contraction apparatus, using the vibration response; and
an estimation unit configured to estimate the presence or absence of an abnormality in accordance with a change in the first index.

Also, in order to achieve the example object described above, an abnormality estimation apparatus according to an example aspect of the invention includes:
a detection unit configured to detect a vibration response when a vehicle passes over an expansion and contraction apparatus, using vibration information indicating vibration that occurs in a bridge;
a first index calculation unit configured to calculate a first index for determining the presence or absence of an abnormality in the expansion and contraction apparatus, using the vibration response;
a vehicle weight estimation unit configured to estimate a weight of the vehicle using the vibration information;
a second index calculation unit configured to calculate a second index indicating a relation between the first index and the weight of the vehicle; and
an estimation unit configured to estimate the presence or absence of an abnormality in accordance with a change in the second index.

Also, in order to achieve the example object described above, an abnormality estimation method according to an example aspect of the invention includes:
a detection step of detecting a vibration response when a vehicle passes over an expansion and contraction apparatus, using vibration information indicating vibration that occurs in a bridge;
a first index calculation step of calculating a first index for determining the presence or absence of an abnormality in the expansion and contraction apparatus, using the vibration response; and
an estimation step of estimating the presence or absence of an abnormality in accordance with a change in the first index.

Also, in order to achieve the example object described above, an abnormality estimation method according to an example aspect of the invention includes:
a detection step of detecting a vibration response when a vehicle passes over an expansion and contraction apparatus, using vibration information indicating vibration that occurs in a bridge;
a first index calculation step of calculating a first index for determining the presence or absence of an abnormality in the expansion and contraction apparatus, using the vibration response;
a vehicle weight estimation step of estimating a weight of the vehicle using the vibration information;
a second index calculation step of calculating a second index indicating the relation between the first index and the weight of the vehicle; and
an estimation step of estimating the presence or absence of an abnormality in accordance with a change in the second index.

Furthermore, in order to achieve the example object described above, a computer-readable recording medium according to an example aspect of the invention includes a program recorded on the computer-readable recording medium, the program including instructions that cause the computer to carry out:
a detection step of detecting a vibration response when a vehicle passes over an expansion and contraction apparatus, using vibration information indicating vibration that occurs in a bridge;
a first index calculation step of calculating a first index for determining the presence or absence of an abnormality in the expansion and contraction apparatus, using the vibration response; and
an estimation step of estimating the presence or absence of an abnormality in accordance with a change in the first index.

Also, in order to achieve the example object described above, a computer-readable recording medium according to an example aspect of the invention includes a program recorded on the computer-readable recording medium, the program including instructions that cause the computer to carry out:
a detection step of detecting a vibration response when a vehicle passes over an expansion and contraction apparatus, using vibration information indicating vibration that occurs in a bridge;
a first index calculation step of calculating a first index for determining the presence or absence of an abnormality in the expansion and contraction apparatus, using the vibration response;
a vehicle weight estimation step of estimating the weight of the vehicle using the vibration information;
a second index calculation step of calculating a second index indicating the relation between the first index and the weight of the vehicle; and
an estimation step of estimating the presence or absence of an abnormality in accordance with a change in the second index.

### Advantageous Effects of the Invention

As described above, according to the invention, it is possible to improve the accuracy for estimating the presence and absence of an abnormality in an expansion and contraction apparatus.

### BRIEF DESCRIPTION OF THE DRAWINGS

FIG. 1 is a diagram for describing an example of an abnormality estimation apparatus.

FIG. 2 is a schematic diagram for describing an example of a bridge.

FIG. 3 is a diagram describing an example of a system that includes an abnormality estimation apparatus.

FIG. 4 is a diagram for describing an exemplary operation of the abnormality estimation apparatus.

FIG. 5 is a diagram for describing an example of an abnormality estimation apparatus.

FIG. 6 is a diagram describing an example of a system that includes an abnormality estimation apparatus.

FIG. 7 is a diagram for describing the method for detecting an axle response.

FIG. 8 is a diagram for describing the method for detecting an axle response.

FIG. 9 is a diagram for describing an example of an axle response.

FIG. 10 is a diagram for describing an example of an axle response subjected to frequency conversion.

FIG. 11 is a diagram for describing conversion information.

FIG. 12 is a diagram for describing the relation between a first index and the weight of a vehicle.

FIG. 13 is a diagram for describing an exemplary operation of the abnormality estimation apparatus.

FIG. 14 is a diagram for describing an example of a vehicle weight estimation operation.

FIG. 15 is a block diagram for showing an example of a computer that realizes the abnormality estimation apparatus according to the first and second example embodiments.

### EXAMPLE EMBODIMENT

### First Example Embodiment

The following describes a first example embodiment of the invention with reference to the drawings. Note that, in the drawings to be described below, the same reference numerals are given to constituent elements that have the same functions or corresponding functions, and a redundant description thereof may be omitted.

### Apparatus Configuration

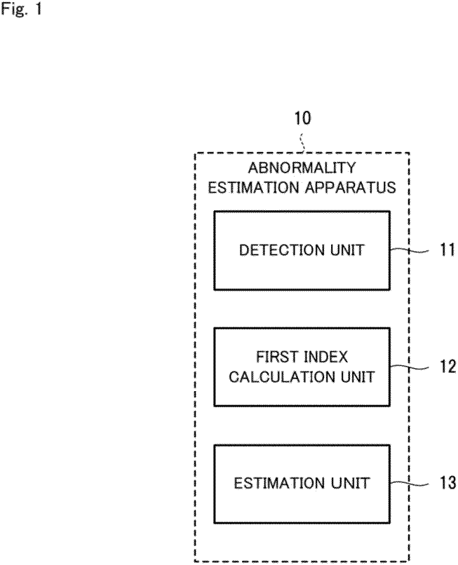

First, the configuration of an abnormality estimation apparatus 10 according to the first example embodiment will be described with reference to FIG. 1. FIG. 1 is a diagram for describing an example of an abnormality estimation apparatus.

The abnormality estimation apparatus 10 shown in FIG. 1 is an apparatus for improving the accuracy for estimating the presence or absence of abnormalities such as degradation and damage in an expansion and contraction apparatus. In addition, as shown in FIG. 1, the abnormality estimation apparatus 10 includes a detection unit 11, a first index calculation unit 12, and an estimation unit 13.

Of these, the detection unit 11 detects a vibration response when a vehicle passes over the expansion and contraction apparatus, using vibration information indicating vibration that occurs in a bridge. The first index calculation unit 12 calculates a first index for determining the presence or absence of an abnormality in the expansion and contraction apparatus, using the vibration response. The estimation unit 13 estimates the presence or absence of an abnormality in accordance with a change in the first index.

An expansion and contraction apparatus is an apparatus for allowing smooth passage of vehicles and people, and is provided between bridge beams or between a bridge abutment and a bridge beam. The expansion and contraction apparatus absorbs expansion and contraction of the bridge caused by a change in atmospheric temperature. The expansion and contraction apparatus absorbs deformation of the bridge caused by an earthquake and passing of vehicles

A vibration response is vibration that occurs in the bridge when a vehicle passes over the expansion and contraction apparatus. The vibration response is vibration that appears from a response start time until a response end time. The vibration response may be an acceleration response or the like.

The first index may be one of or both the sum of vibration levels for a vibration response and the centroid of a frequency spectrum density, for example. The first index will be described in detail later.

A change in the first index is an index indicating the difference between a first index estimated at the time point of a previous diagnosis and a first index estimated at a time point after the previous diagnosis, for example.

In this manner, in the embodiment, when a vehicle passes over the expansion and contraction apparatus, a first index is calculated using vibration that occurs in the bridge, and the presence or absence of an abnormality is estimated in accordance with a change in the calculated first index, and thus it is possible to accurately estimate the presence or absence of an abnormality in the expansion and contraction apparatus.

In addition, it suffices that vibration that occurs in the bridge can be collected at a portion of the bridge, and thus it is possible to accurately estimate the presence or absence of an abnormality in the expansion and contraction apparatus without imposing traffic lane regulations or the like.

Furthermore, it suffices that vibration that occurs in the bridge can be collected, and thus it is possible to accurately estimate the presence or absence of an abnormality in the expansion and contraction apparatus without performing any manual operation.

### System Configuration

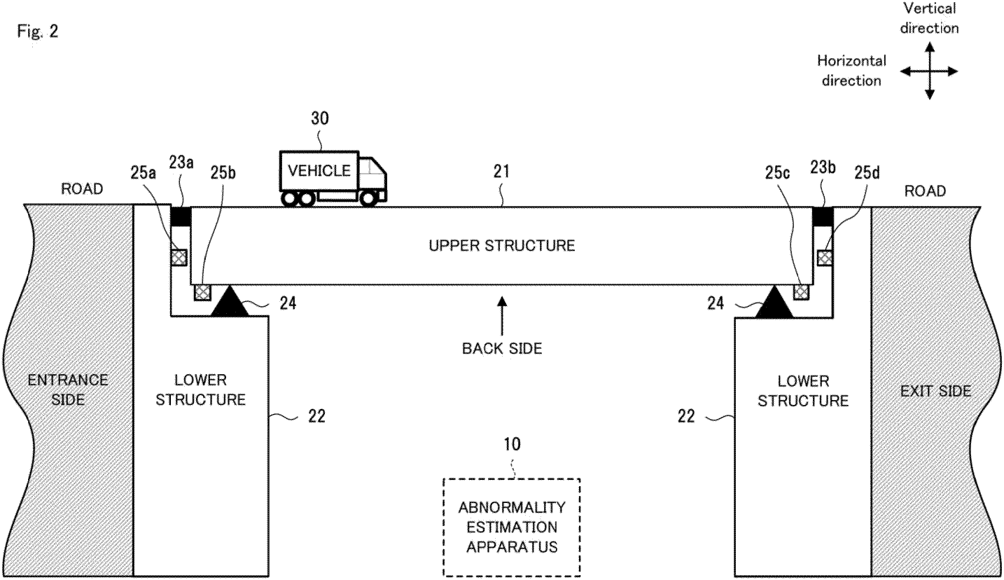

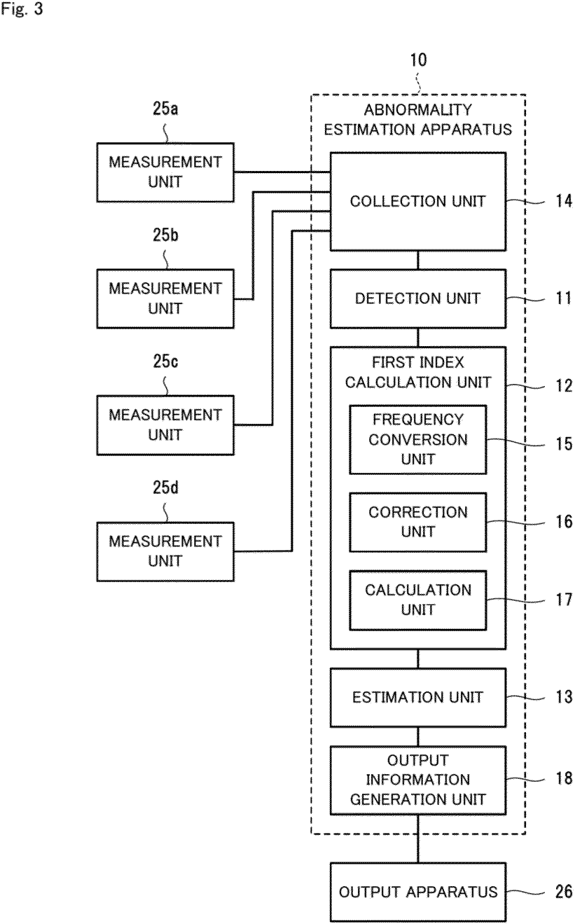

Next, the configuration of the abnormality estimation apparatus 10 according to the embodiment will be described in more detail with reference to FIGS. 2 and 3. FIG. 2 is a schematic diagram for describing an example of a bridge. FIG. 3 is a diagram describing an example of a system that includes an abnormality estimation apparatus.

### A Structural Object will Be Described

A bridge shown in FIG. 2 includes an upper structure 21, a lower structure 22, expansion and contraction apparatuses 23 (23a and 23b), bearing parts 24, and the like. In addition, measurement units 25 (25a, 25b, 25c, and 25d) are provided on the bridge shown in FIG. 2. Furthermore, a vehicle 30 shown in FIG. 2 passes over the expansion and contraction apparatus 23a from the entrance side of the upper structure 21, and moves toward the exit side of the upper structure 21.

The upper structure 21 includes a floor structure and a main structure. The floor structure is formed of a floor slab, floor framing, and the like. The main structure includes a main beam and the like, supports the floor structure, and transmits a load to the lower structure 22.

The lower structure 22 includes bridge abutments provided at two ends of the bridge and bridge piers provided midway on the bridge, which support the upper structure 21 and transmit a load to the ground, and a base that supports the bridge abutments and the bridge piers.

The expansion and contraction apparatuses 23 (23a, 23b) are apparatuses that are each provided at a joint between a road and the bridge or a joint between bridge beams (play space), and enable expansion and contraction of the bridge. In the example in FIG. 2, the expansion and contraction apparatuses 23 are each provided at a joint between the road and the bridge.

The bearing parts 24 are members installed between the upper structure 21 and the lower structure 22. The bearing parts 24 transmit a load that acts on the upper structure 21 to the lower structure 22.

The measurement units 25 are sensors that measure vibration of the bridge. The measurement unit 25a is mounted on the lower structure 22 on the entrance side. The measurement unit 25b is mounted on the upper structure 21 on the entrance side. The measurement unit 25c is mounted on the upper structure 21 on the exit side. The measurement unit 25d is mounted on the lower structure 22 on the exit side.

Note that, when an expansion and contraction apparatus 23 provided at a joint between bridge beams is targeted, a measurement unit 25 is mounted to the upper structure 21 or the lower structure 22 near the expansion and contraction apparatus 23, and thereby measures vibration of the bridge. Note that the installation position of the measurement unit 25 is not limited to the above position.

The vehicle 30 travels on the upper structure 21 from the entrance side to the exit side, and makes an impact on the upper structure 21 from each axle. Note that the vehicle 30 is a vehicle that includes at least one or more axles for attaching wheels to the vehicle. The vehicle 30 may be an automobile, a train, or the like.

### A System will Be Described

As shown in FIG. 3, a system according to the embodiment includes the measurement units 25 and an output apparatus 26 in addition to the abnormality estimation apparatus 10. In addition, the system shown in FIG. 3 is a system that is used when estimating the presence or absence of an abnormality in an expansion and contraction apparatus.

The measurement units 25 measure vibration, and transmit vibration information indicating the measured vibration to the abnormality estimation apparatus 10. In the example in FIG. 2, the measurement units 25a and 25b measure vibration in the vicinity of the expansion and contraction apparatus 23a. The measurement units 25c and 25d measure vibration in the vicinity of the expansion and contraction apparatus 23b.

Each of the measurement units 25 (25a, 25b, 25c, and 25d) is a three-dimensional acceleration sensor, a fiber sensor, or the like. The vibration information is information that includes acceleration data and the like.

In the example in FIG. 2, when the vehicle 30 passes over a joint between an expansion and contraction apparatus 23 and the upper structure 21 (a level difference: a vibration producing structure that causes the structural object to vibrate when the vehicle 30 passes over the structure), an impact acts on the upper structure 21 with the joint serving as a supporting point, and the upper structure 21 vibrates.

Specifically, a measurement unit 25 first measures an acceleration at a position where the measurement unit 25 is mounted. Next, the measurement unit 25 transmits a signal or data indicating the measured acceleration to the abnormality estimation apparatus 10. Communication such as wired or wireless communication is used for interaction between the measurement unit 25 and the abnormality estimation apparatus 10.

Each measurement unit 25 is installed at a position close to an expansion and contraction apparatus 23, on an end surface of the upper structure 21 or a side surface of the lower structure 22. Note that the measurement unit 25 is desirably installed near the expansion and contraction apparatus. This is because, the closer the measurement unit is to the expansion and contraction apparatus, the more the influence of the vibration properties of the bridge can be reduced. Also, it is easier to catch a vibration response at a position closer to the expansion and contraction apparatus, and an estimation error can be reduced.

The measurement unit 25 is desirably installed at a position where an acceleration of a response (vibration response) when an axle passes over the vibration producing structure is higher than or equal to a predetermined threshold value (for example, 1 [m/s²] or higher). Note that the position at which the measurement unit 25 is installed is not limited to the above position.

It is possible to avoid exposure to rain and the like and to reduce the maintenance cost by installing the measurement unit 25 on the back side of the upper structure 21 or a side surface of the lower structure 22. In addition, the expansion and contraction apparatus 23 has scaffolding (a bridge abutment, a bridge pier, and the like), and is easy to access compared with a case where the measurement unit 25 is installed at the center of the upper structure 21, and thus the labor and costs involved with installing the measurement unit 25 can be suppressed.

The abnormality estimation apparatus 10 is an information processing apparatus such as a server computer, a personal computer, or a mobile terminal in which one of or both a CPU (Central Processing Unit) and an FPGA (Field-Programmable Gate Array) are installed, for example.

The output apparatus 26 obtains output information subjected to conversion by an output information generation unit 18 into a format that can be output, and outputs a generated image, sound, and the like based on the output information. The output apparatus 26 is an image display apparatus that uses liquid crystal, organic EL (Electro Luminescence), or a CRT (Cathode Ray Tube), for example. Furthermore, the image display apparatus may include a sound output device such as a speaker, for example. Note that the output apparatus 26 may also be a print apparatus such as a printer. Note that the output information generation unit 18 will be described later.

### The Abnormality Estimation Apparatus will Be Described

As shown in FIG. 3, the abnormality estimation apparatus 10 includes a collection unit 14, a frequency conversion unit 15, a correction unit 16, a calculation unit 17, and the output information generation unit 18 in addition to the detection unit 11, the first index calculation unit 12, and the estimation unit 13.

The collection unit 14 collects vibration information indicating vibration that occurs in the bridge from each of the measurement units 25. Specifically, first, if the measurement units 25 are acceleration sensors, the collection unit 14 receives vibration information that includes acceleration data, from the measurement units 25. Next, the collection unit 14 outputs vibration information to the detection unit 11.

The detection unit 11 detects a vibration response that is produced when an axle of the vehicle 30 passes over the expansion and contraction apparatus 23, using the vibration information. Specifically, the detection unit 11 first obtains the vibration information obtained by the measurement units 25 from the collection unit 14. Next, the detection unit 11 detects vibration that occurs in the bridge (a vibration response) as a result of the vehicle 30 passing over the expansion and contraction apparatus 23, using the acceleration data included in the vibration information. The detection unit 11 then outputs the vibration response to the first index calculation unit 12.

As a method for detecting a vibration response, for example, first, when the obtained acceleration data exceeds a predetermined threshold value, the detection unit 11 sets the time at which the threshold value is exceeded as a reference time t0. The threshold value is determined through experiments, simulation, or the like.

In addition, a configuration may also be adopted in which local maximum points are obtained for a signal that takes the absolute value of acceleration data, and a time at which the highest local maximum point thereof was observed is used as the reference time t0.

Next, the detection unit 11 sets a time preceding the reference time t0 by a period T1 as a response start time ts, sets a time later than the reference time t0 as a response end time te, and sets acceleration data in this period (window) as a vibration response. The periods T1 and T2 are determined through experiments, simulation, or the like.

Note that a method for detecting a vibration response is not limited to the above method, and it suffices that a vibration response can be detected.

The first index calculation unit 12 calculates a first index for determining the presence or absence of an abnormality in the expansion and contraction apparatus 23, using the vibration response. Note that the first index calculation unit 12 includes the frequency conversion unit 15, the correction unit 16, and the calculation unit 17.

### The First Index Calculation Unit will Be Described in Detail

The frequency conversion unit 15 performs frequency conversion on a vibration response, and calculates a frequency spectrum. Specifically, the frequency conversion unit 15 first obtains a vibration response from the detection unit 11. Next, the frequency conversion unit 15 performs frequency conversion on the vibration response, and calculates a frequency spectrum. The frequency conversion unit 15 then outputs the frequency spectrum to the correction unit 16.

Fourier transformation is performed as frequency conversion on acceleration data obtained in time series (a signal x(t) (ts ≤ t ≤ te)), and a frequency spectrum is obtained. Note that the sampling frequency of the signal x (t) is expressed as “fs”. In addition, the intensity (vibration level) of the frequency spectrum is expressed as “A(f)” (0 ≤ f ≤ fs/2).

The correction unit 16 corrects a vibration response based on the position of the measurement units 25 that measure vibration occurring in the bridge. Specifically, the correction unit 16 first obtains a frequency spectrum from the frequency conversion unit 15. Next, the correction unit 16 performs correction processing on the frequency spectrum. The correction unit 16 then outputs a result of correction processing to the calculation unit 17.

A band-limiting filter or a weighing filter is used for correction processing, for example. Correction processing that uses a band-limiting filter is expressed by Formula 1.

$$\begin{matrix}{\text{A}}_{\text{b}} \left(\text{f}\right) = \text{A} \left(\text{f}\right) \times {\text{F}}_{\text{b}} \left(\text{f}\right) \\ \\ \text{A} \left(\text{f}\right) : \text{intensity} \left(\text{vibration level}\right) \text{of the frequency spectrum} \\ {\text{A}}_{\text{b}} \left(\text{f}\right) : \text{frequency spectrum after band limiting processing} \\ {\text{F}}_{\text{b}} \left(\text{f}\right) : \text{band-limiting filter}\end{matrix}$$

A band-limiting filter F_{b}(f) is designed to remove vibration that occurs due to travelling of the vehicle 30, for example. In that case, a vibration level Ap(f) is calculated, the vibration level Ap being obtained by calculating a time tp at which a peak of vibration that occurs when the vehicle 30 passes over the expansion and contraction apparatus 23 appears, and performing Fourier transformation on acceleration data x(t) (tp-Δt ≤t ≤tp) observed before the time tp. Accordingly, a band-limiting filter that removes a bandwidth in which vibration occurs due to travelling of the vehicle 30 can be expressed by Formula 2.

$${\text{F}}_{\text{b}} \left(\text{f}\right) = \left\{\begin{matrix}1 , & {\text{if A}}_{\text{p}} \left(\text{f}\right) \geq θ , \\ 0 , & \text{otherwise} \text{.}\end{matrix}\right)$$

Also, correction processing that uses a weighting filter can be expressed as indicated by Formula 3.

$$\begin{matrix}{\text{A}}_{\text{w}} \left(\text{f}\right) = \text{A} \left(\text{f}\right) \times {\text{F}}_{\text{w}} \left(\text{f}\right) \\ \\ \text{A} \left(\text{f}\right) : \text{intensity} \left(\text{vibration level}\right) \text{of the frequency spectrum} \\ {\text{A}}_{\text{w}} \left(\text{f}\right) : \text{frequency spectrum after applying weighting filter} \\ {\text{F}}_{\text{w}} \left(\text{f}\right) : \text{weighting filter}\end{matrix}$$

A weighting filter F_{w}(t) is designed to reduce vibration that occurs due to travelling of the vehicle 30, for example. An example of the weighting filter F_{w}(f) is expressed by Formula 4.

$${\text{F}}_{\text{w}} \left(\text{f}\right) = \left({max}_{\text{f}} {\text{A}}_{\text{p}} \left(\text{f}\right) - {\text{A}}_{\text{p}} \left(\text{f}\right)\right) \times \frac{1}{\left({max}_{\text{f}} {\text{A}}_{\text{p}} \left(\text{f}\right) - {min}_{\text{f}} {\text{A}}_{\text{p}} \left(\text{f}\right)\right)}$$

In addition, for example, an A property, a C property, and a Z property that are weights that consider the properties of the human auditory sense may be used for the weighting filter F_{w}(f). Furthermore, both the band-limiting filter and the weighing filter may also be used for correction processing.

The calculation unit 17 calculates a first index using the result of correction processing. Specifically, the calculation unit 17 first obtains the result of correction processing from the correction unit 16. Next, the calculation unit 17 calculates one of or both the sum of vibration levels and the centroid of a spectrum density using the result of correction processing.

The sum S of vibration levels can be calculated using Formula 5.

$$\begin{matrix}\text{S=} {\sum }_{\text{f}} \text{A'} \left(\text{f}\right) \\ \\ \text{S} \text{:} \text{sum of vibration levels} \\ \text{A'} \left(\text{f}\right) : \text{frequency spectrum after correction processing}\end{matrix}$$

A centroid C of a spectrum density can be calculated using Formula 6.

$$\begin{matrix}\text{C} = \frac{\sum {}_{\text{f}} {\text{A}}^{′} \left(\text{f}\right) \times \text{f}}{\sum {}_{\text{f}} {\text{A}}^{′} \left(\text{f}\right)} \\ \\ \text{C} \text{} \text{:} \text{centroid of a spectrum density} \\ \text{A'} \left(\text{f}\right) : \text{frequency spectrum after correction processing}\end{matrix}$$

The estimation unit 13 estimates the presence or absence of an abnormality in accordance with a change in a first index. Specifically, first, the estimation unit 13 obtains a first index (one of or both the sum S of vibration levels and the centroid C of a spectrum density) from the first index calculation unit 12. Next, the estimation unit 13 calculates the difference between a first index estimated in a previous diagnosis and a first index estimated in a diagnosis performed after the previous diagnosis, which are stored in a storage unit. The difference between a first index estimated in a diagnosis three months ago and a first index estimated in the current diagnosis is calculated, for example.

Next, if the calculated difference is higher than or equal to a predetermined threshold value Th, the estimation unit 13 estimates that there is an abnormality in the expansion and contraction apparatus 23. The estimation unit 13 then outputs the estimation result to the output information generation unit 18. The threshold value Th is determined through experiments, simulation, or the like.

In the case of the sum of vibration levels, for example, the estimation unit 13 calculates the difference ΔS (=S2-S1) between the sum S1 of vibration levels estimated in a previous diagnosis and the sum S2 of vibration levels estimated in a diagnosis performed after the previous diagnosis. The estimation unit 13 then determines whether or not the difference ΔS is higher than or equal to a predetermined threshold value Ths. If the difference ΔS is higher than or equal to the threshold value Ths, the estimation unit 13 estimates that there is an abnormality in the expansion and contraction apparatus 23.

Also, in the case of the centroid of a spectrum density, the estimation unit 13 calculates the difference ΔC (=C2-C1) between a centroid C1 of a spectrum density estimated in a previous diagnosis and a centroid C2 of a spectrum density estimated in a diagnosis performed after the previous diagnosis. The estimation unit 13 then determines whether or not the difference ΔC is higher than or equal to a predetermined threshold value Thc. If the difference ΔC is higher than or equal to the threshold value Thc, the estimation unit 13 estimates that there is an abnormality in the expansion and contraction apparatus 23.

The output information generation unit 18 generates output information for causing the output apparatus 26 to output abnormality estimation results, and outputs the generated output information to the output apparatus 26. The output apparatus 26 then outputs abnormality estimation results respectively corresponding to the measurement units 25 based on the output information. Note that, not only an abnormality estimation result, but also the waveform of the vibration response, the waveform of the frequency spectrum, the first index, and the like may be displayed.

### Apparatus Operations

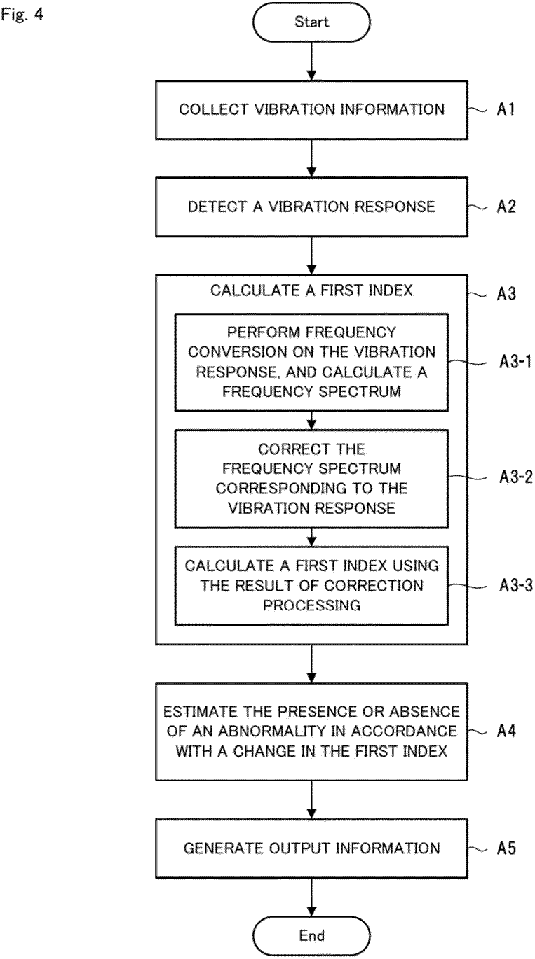

Next, operations of the abnormality estimation apparatus according to the first example embodiment of the invention will be described with reference to FIG. 4. FIG. 4 is a diagram for describing an exemplary operation of the abnormality estimation apparatus. In the following description, FIGS. 1 to 3 will be referred to as appropriate. In addition, in the first example embodiment, an abnormality estimation method is carried out by causing the abnormality estimation apparatus to operate. Thus, a description of the abnormality estimation method according to the first example embodiment is replaced with the following description of operations of the abnormality estimation apparatus.

As shown in FIG. 4, first, the collection unit 14 collects vibration information indicating vibration that occurs in the bridge, from each of the measurement units 25 (step A1).

Specifically, in step A1, first, if the measurement units 25 are acceleration sensors, the collection unit 14 receives vibration information that includes acceleration data, from each of the measurement units 25. Next, in step A1, the collection unit 14 outputs the vibration information to the detection unit 11.

Next, the detection unit 11 detects a vibration response that is produced when an axle of the vehicle 30 passes over the expansion and contraction apparatus 23, using the vibration information (step A2).

Specifically, in step A2, first, the detection unit 11 obtains vibration information obtained by each of the measurement units 25 from the collection unit 14. Next, in step A2, the detection unit 11 detects vibration that occurs in the bridge (vibration response) due to the vehicle 30 passing over the expansion and contraction apparatus 23, using the acceleration data included in the vibration information. Then, in step A2, the detection unit 11 outputs the vibration response to the first index calculation unit 12.

Next, the first index calculation unit 12 calculates a first index for determining the presence or absence of an abnormality in the expansion and contraction apparatus 23 using the vibration response (step A3).

### Step A3 will Be Described in Detail

First, the frequency conversion unit 15 performs frequency conversion on the vibration response, and calculates a frequency spectrum (step A3-1).

Specifically, in step A3-1, first, the frequency conversion unit 15 obtains the vibration response from the detection unit 11. Next, in step A3-1, the frequency conversion unit 15 performs frequency conversion on the vibration response, and calculates a frequency spectrum. Then, in step A3-1, the frequency conversion unit 15 outputs the frequency spectrum to the correction unit 16.

Next, the correction unit 16 corrects the frequency spectrum corresponding to the vibration response based on the position of a measurement unit 25 that measures vibration that occurs in the bridge (step A3-2).

Specifically, in step A3-2, first, the correction unit 16 obtains the frequency spectrum from the frequency conversion unit 15. Next, in step A3-2, the correction unit 16 performs correction processing on the frequency spectrum using one of or both the band-limiting filter and the weighing filter. Then, in step A3-2, the correction unit 16 outputs the result of correction processing to the calculation unit 17.

Next, the calculation unit 17 calculates a first index using the result of correction processing (step A3-3).

Specifically, in step A3-3, first, the calculation unit 17 obtains the result of correction processing from the correction unit 16. Next, in step A3-3, the calculation unit 17 calculates one of or both the sum of vibration levels and the centroid of the spectrum density using the result subjected to correction processing.

Next, the estimation unit 13 estimates the presence or absence of an abnormality in accordance with a change in the first index (step A4).

Specifically, in step A4, first, the estimation unit 13 obtains the first index (one of or both the sum S of vibration levels and the centroid C of the spectrum density) from the first index calculation unit 12. Next, in step A4, the estimation unit 13 calculates the difference between a first index estimated in a previous diagnosis and a first index estimated in a diagnosis performed after the previous diagnosis, which are stored in the storage unit.

Next, in step A4, if the calculated difference is higher than or equal to the predetermined threshold value Th, the estimation unit 13 estimates that there is an abnormality in the expansion and contraction apparatus 23. The estimation unit 13 then outputs the estimation result to the output information generation unit 18. The threshold value Th is determined through experiments, simulation, or the like.

In the case of the sum of vibration levels, for example, the estimation unit 13 calculates the difference ΔS (=S2-S1) between the sum S1 of vibration levels estimated in a previous diagnosis and the sum S2 of vibration levels estimated in a diagnosis performed after the previous diagnosis. The estimation unit 13 then determines whether or not the difference ΔS is higher than or equal to the predetermined threshold value Ths. If the difference ΔS is higher than or equal to the threshold value Ths, the estimation unit 13 estimates that there is an abnormality in the expansion and contraction apparatus 23.

Also, in the case of the centroid of the spectrum density, the estimation unit 13 calculates the difference ΔC (=C2-C 1) between the centroid C1 of a spectrum density estimated in a previous diagnosis and the spectrum density C2 estimated in a diagnosis performed after the previous diagnosis. The estimation unit 13 then determines whether or not the difference ΔC is higher than or equal to the predetermined threshold value Thc. If the difference ΔC is higher than or equal to the threshold value Thc, the estimation unit 13 estimates that there is an abnormality in the expansion and contraction apparatus 23.

Next, the output information generation unit 18 generates output information for causing the output apparatus 26 to output an abnormality estimation result, and outputs the generated output information to the output apparatus 26 (step A5). The output apparatus 26 then outputs abnormality estimation results respectively corresponding to the measurement units 25 based on the output information. Note that, not only an estimation result, but also the waveform of the vibration response, the waveform of the frequency spectrum, and the first index may be displayed.

### Effects in First Example Embodiment

As described above, according to the embodiment, when the vehicle 30 passes over the expansion and contraction apparatus 23, a first index is calculated using vibration that occurs in the bridge, and the presence or absence of an abnormality is estimated in accordance with a change in the calculated first index, and thus it is possible to accurately estimate the presence or absence of an abnormality in the expansion and contraction apparatus 23.

In addition, it suffices that vibration that occurs in the bridge can be collected at a portion of the bridge, and thus it is possible to accurately estimate the presence or absence of an abnormality in the expansion and contraction apparatus 23 without imposing traffic lane regulations or the like.

In addition, it suffices that vibration that occurs in the bridge can be collected, and thus it is possible to accurately estimate the presence or absence of an abnormality in the expansion and contraction apparatus 23 without performing any manual operation.

Furthermore, it is possible to more accurately estimate the presence or absence of an abnormality in the expansion and contraction apparatus 23 by performing correction processing.

### Program

The program according to an embodiment 1 of the invention may be a program that causes a computer to execute steps A1 to A5 shown in FIG. 4. By installing this program in a computer and executing the program, the abnormality estimation apparatus and the abnormality estimation method according to the example embodiment 1 can be realized. In this case, the processor of the computer performs processing to function as the collection unit 14, the detection unit 11, the first index calculation unit 12 (the frequency conversion unit 15, the correction unit 16, the calculation unit 17), the estimation unit 13, and the output information generation unit 18.

Also, the program according to the embodiment may be executed by a computer system constructed by a plurality of computers. In this case, for example, each computer may function as any of the collection unit 14, the detection unit 11, the first index calculation unit 12 (the frequency conversion unit 15, the correction unit 16, the calculation unit 17), the estimation unit 13, and the output information generation unit 18.

### Second Example Embodiment

The following describes a second embodiment of the invention with reference to the drawings. Note that, in the drawings to be described below, the same reference numerals are given to constituent elements that have the same functions or corresponding functions, and a redundant description thereof may be omitted.

### Apparatus Configuration

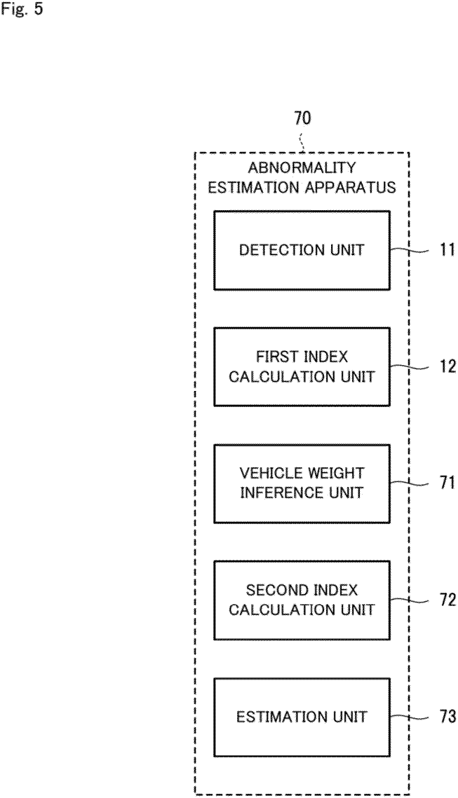

The configuration of an abnormality estimation apparatus 70 according to the second embodiment will be described with reference to FIG. 5. FIG. 5 is a diagram for describing an example of the abnormality estimation apparatus.

The abnormality estimation apparatus 70 shown in FIG. 5 is an apparatus that improves the accuracy for estimating the presence and absence of an abnormality in an expansion and contraction apparatus. In addition, as shown in FIG. 5, the abnormality estimation apparatus 70 includes a detection unit 11, a first index calculation unit 12, a vehicle weight estimation unit 71, a second index calculation unit 72, and an estimation unit 73.

Of these, the detection unit 11 detects a vibration response when a vehicle passes over the expansion and contraction apparatus, using vibration information indicating vibration that occurs in the bridge. The first index calculation unit 12 calculates a first index for determining the presence or absence of an abnormality in the expansion and contraction apparatus, using the vibration response. The vehicle weight estimation unit 71 estimates the weight of the vehicle using the vibration information. The second index calculation unit 72 calculates a second index indicating the relation between the first index and the weight of the vehicle. The estimation unit 73 estimates the presence or absence of an abnormality in accordance with a change in the second index.

The second index is an index indicating the correlation between the first index (the sum of vibration levels or the centroid of a spectrum density) and the vehicle weight. The second index will be described later in detail.

A change in the second index refers to the difference between a second index estimated in a previous diagnosis and a second index estimated in a diagnosis performed after the previous diagnosis, for example.

As described above, in the embodiment, when a vehicle passes over the expansion and contraction apparatus, a second index indicating the relation between the first index and the weight of the vehicle is calculated using vibration that occurs in the bridge, and the presence or absence of an abnormality is estimated in accordance with a change in the calculated second index, and thus it is possible to more accurately estimate the presence or absence of an abnormality in the expansion and contraction apparatus.

In addition, it suffices that vibration that occurs in the bridge can be collected at a portion of the bridge, and thus it is possible to accurately estimate the presence or absence of an abnormality in the expansion and contraction apparatus without imposing traffic lane regulations or the like.

Furthermore, it suffices that vibration that occurs in the bridge can be collected, and thus it is possible to accurately estimate the presence or absence of an abnormality in the expansion and contraction apparatus without performing any manual operation.

### System Configuration

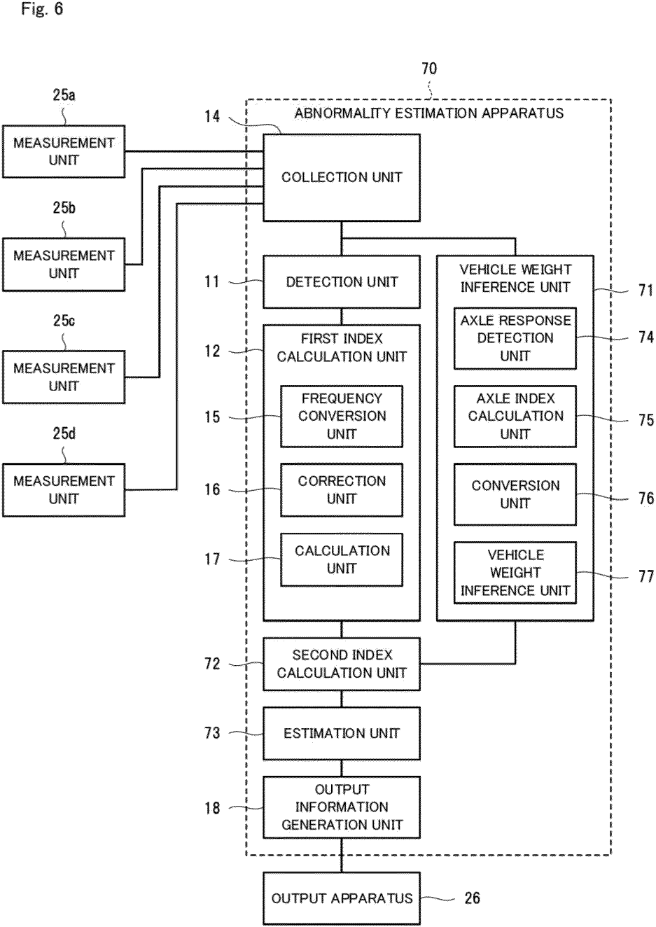

Next, the configuration of the abnormality estimation apparatus 70 according to the embodiment will be described in more detail with reference to FIG. 6. FIG. 6 is a diagram describing an example of a system that includes the abnormality estimation apparatus.

As shown in FIG. 6, the system according to the embodiment includes the measurement units 25 and the output apparatus 26 in addition to the abnormality estimation apparatus 70. In addition, the system shown in FIG. 3 is a system that is used when estimating the presence or absence of an abnormality in the expansion and contraction apparatus.

The abnormality estimation apparatus 70 is an information processing apparatus such as a server computer, a personal computer, or a mobile terminal in which one of or both a CPU and an FPGA are installed, for example

Note that the measurement units 25 and the output apparatus 26 have been described already in the first example embodiment, and thus a detailed description thereof is omitted.

The abnormality estimation apparatus will be described.

As shown in FIG. 6, the abnormality estimation apparatus 70 includes the collection unit 14 and the output information generation unit 18 in addition to the detection unit 11, the first index calculation unit 12 (the frequency conversion unit 15, the correction unit 16, and the calculation unit 17), the vehicle weight estimation unit 71, the second index calculation unit 72, and the estimation unit 73.

Note that the collection unit 14, the detection unit 11, the first index calculation unit 12, the frequency conversion unit 15, the correction unit 16, the calculation unit 17, and the output information generation unit 18 have been described already in the first example embodiment, and thus a detailed description thereof is omitted.

The vehicle weight estimation unit 71 estimates the weight of the vehicle 30. Specifically, the vehicle weight estimation unit 71 first obtains vibration information from the collection unit 14. Next, the vehicle weight estimation unit 71 extracts a response start time, a response end time, and the window width of an axle response, using acceleration data included in the vibration information. The vehicle weight estimation unit 71 includes an axle response detection unit 74, an axle index calculation unit 75, a conversion unit 76, and a vehicle weight estimation unit 77.

The axle response detection unit 74 detects an axle response that is produced when an axle of the vehicle 30 passes over the expansion and contraction apparatus 23, using the vibration information. Specifically, the axle response detection unit 74 first obtains vibration information from the collection unit 14. Next, the axle response detection unit 74 extracts the response start time, the response end time, and the window width of the axle response using the acceleration data included in the vibration information.

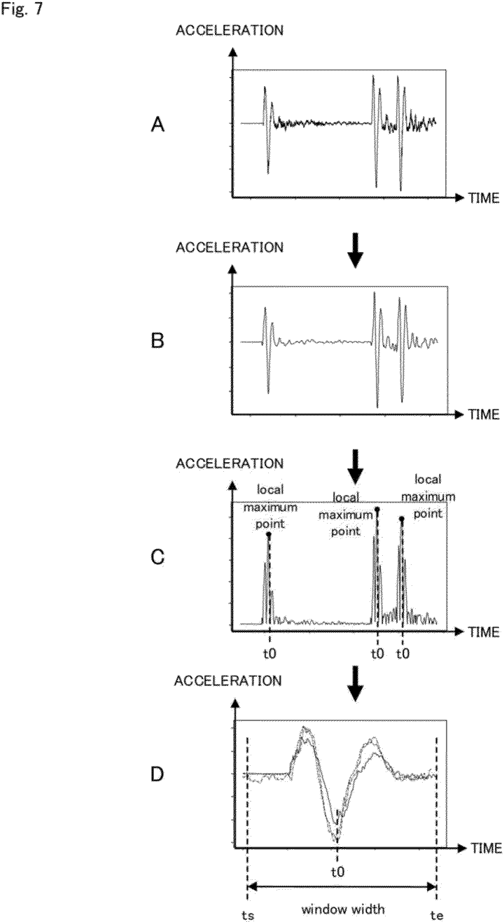

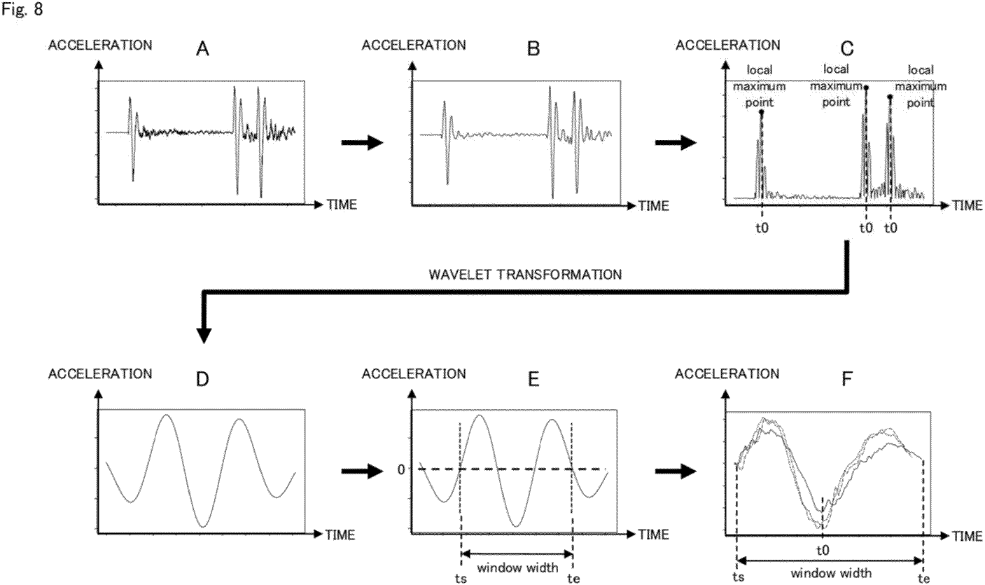

Detection of an axle response can be achieved by (1) an axle response detection method shown in FIG. 7 or (2) an axle response detection method shown in FIG. 8, for example. FIGS. 7 and 8 are diagrams for describing the method for detecting an axle response. Note that the waveform of an acceleration shown in FIGS. 7 and 8 indicates an acceleration generated in a structural object when the vehicle 30 that has three axles passes over the expansion and contraction apparatus 23. Therefore, in the examples in FIGS. 7 and 8, three axle responses are detected.

(1) The axle response detection method will be described.

First, the axle response detection unit 74 performs frequency band limitation on acceleration data such as that shown in A in FIG. 7, using filtering processing with a band pass filter or the like, and generates data such as that shown in B in FIG. 7, the data being obtained by removing noise components and the like from the acceleration data.

Next, the axle response detection unit 74 obtains the absolute values of amplitude values for the generated data indicated by B in FIG. 7, and generates data such as that shown in C in FIG. 7. The axle response detection unit 74 extracts local maximum points using the generated absolute value data of the amplitude values. Since, for example, the number of axles is three as indicated by C in FIG. 7, three local maximum points are extracted for the respective axles.

Next, the axle response detection unit 74 obtains a window width for each extracted local maximum point. A window width is represented by a predetermined time period that includes a time t0 of the local maximum point, for example. Therefore, when the time of an extracted local maximum point is indicated by t0 as shown in C in FIG. 7, the response start time is a time ts that precedes the time t0 and the response end time is a time te that comes after the time t0 as shown in D in FIG. 7. Note that a window width is desirably set to a time of 40 to 50 [ms] centered on the time t0 of the local maximum point.

Note that, in D in FIG. 7, pieces of acceleration data (waveforms) of respective axles are superimposed on each other using, as references, the times t0 of local maximum points extracted for the three axles. Note that the window width may be changed for each axle. The window width may be changed in accordance with the position of the axle of the vehicle, for example,

In this manner, in the method (1), the axle response detection unit 74 extracts an axle response for each axle as described above, and outputs the axle response for each axle to the axle index calculation unit 75.

(2) The axle response detection method will be described.

First, the axle response detection unit 74 performs filtering processing on acceleration data such as that shown in A in FIG. 8, using a wavelet filter, forms acceleration data, and generates data such as that shown in B in FIG. 8.

Next, the axle response detection unit 74 obtains the absolute values of amplitude values for the generated data shown in B in FIG. 8, and generates data such as that shown in C in FIG. 8. The axle response detection unit 74 then extracts local maximum points using the generated absolute value data of the amplitude values. Since the number of axles is three as shown in C in FIG. 8, three local maximum points are extracted for the respective axles, for example.

Next, the axle response detection unit 74 performs wavelet transformation on the absolute value data of the amplitude values such as those shown in C in FIG. 8, extracts the maximum points of a wavelet coefficient, and obtains data such as that shown in D in FIG. 8 (wavelet waveform).

Next, the axle response detection unit 74 obtains a window width for each of the extracted local maximum points. The window width is obtained by extracting zero intersections of the wavelet waveform as indicated by E in FIG. 8, for example. The window width can be expressed by the response start time ts and the response end time te as indicated by E in FIG. 8.

Next, the axle response detection unit 74 extracts an axle response such as that shown in F in FIG. 8, using the window width expressed by the response start time ts and the response end time te, which is shown in E in FIG. 8.

Note that, in F in FIG. 8, pieces of acceleration data (waveforms) of respective axles are superimposed on each other using, as references, the times t0 of the local maximum points extracted for the three axles.

In this manner, in the method in (2), the axle response detection unit 74 extracts an axle response for each axle as described above, and outputs the axle response for each axle to the axle index calculation unit 75.

The axle index calculation unit 75 calculates an axle index for each axle based on an axle response. Specifically, the axle index calculation unit 75 first obtains an axle response for each axle from the axle response detection unit 74. Next, the axle index calculation unit 75 uses the acceleration data included in the axle response, and calculates a square-root of sum of squares of the acceleration, the maximum amplitude value of the acceleration data, or the maximum value of a spectrum amplitude obtained by performing frequency conversion on the acceleration data. Next, the axle index calculation unit 75 outputs the axle index calculated for each axle to the conversion unit 76.

Calculation of an axle index will be described.

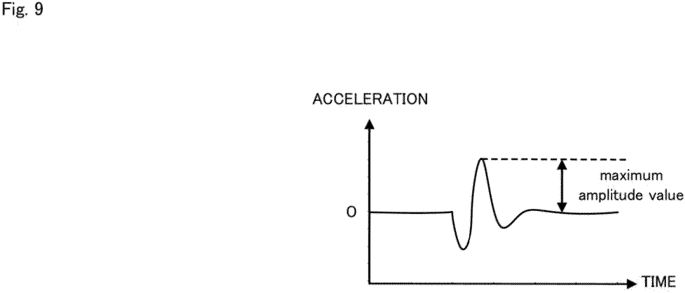

In a method for calculating the square-root of sum of squares of an acceleration, for example, if the axle response is acceleration data such as that shown in FIG. 9, a square-root of sum of squares is calculated using Formula 7. FIG. 9 is a diagram for describing an example of an axle response.

$$\begin{matrix}\text{Vi=} \sqrt{\sum {}_{\text{i} = 0}^{8} {\left|{a}_{{t}_{i}}\right|}^{2}} \\ \text{Vi} \text{: axle response} \\ {\text{a}}_{{t}_{i}} \text{:} \text{acceleration on rate amplitude}\end{matrix}$$

In a method for calculating the maximum amplitude value of acceleration data, for example, if the axle response is acceleration data such as that shown in FIG. 9, the maximum amplitude value is calculated based on acceleration data as shown in FIG. 9.

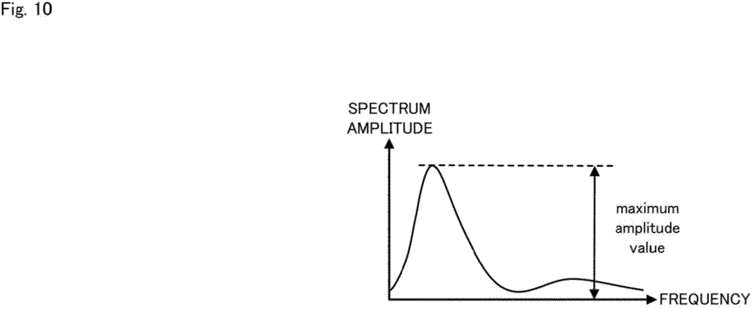

In a method for calculating the maximum value of a spectrum amplitude obtained by performing frequency conversion on acceleration data, for example, if the axle response is a time-acceleration such as that shown in FIG. 9, frequency conversion is performed on the axle response to obtain a frequency-spectrum amplitude such as that shown in FIG. 10. The maximum amplitude value of the spectrum amplitude is then calculated as shown in FIG. 10. FIG. 10 is a diagram for describing an example of an axle response subjected to frequency conversion.

Using the axle index, the conversion unit 76 refers to conversion information that indicates the correlation between axle index and axle weight and is stored in advance, and calculates an axle weight. Specifically, first, the conversion unit 76 obtains an axle index calculated for each axle. Next, the conversion unit 76 converts each axle index into an axle weight for each axle.

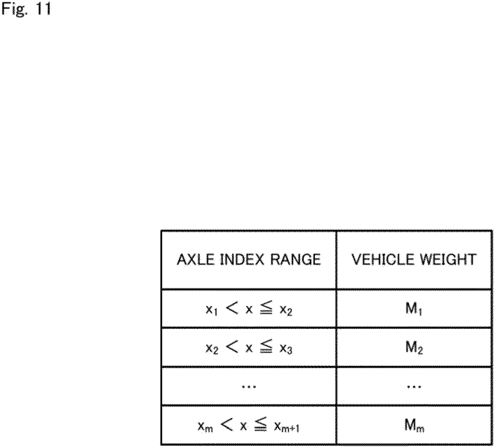

The conversion information is information indicating the correlation between an axle index and an axle weight. A correlation in the conversion information can be expressed by a regression function, for example. The regression function is a linear function, an n-order polynomial function, a non-linear function, or the like. In addition, conversion information may be used as a table such as that shown in FIG. 11. FIG. 11 is a diagram for describing conversion information.

When the table shown in FIG. 11 is used, if the axle index is x, the conversion unit 76 detects an axle index range that includes the axle index x (a range of x₁ < x ≤ x₂, a range of x₂ < x ≤ x₃ ... a range of xₘ< x ≤ xₘ+1), selects vehicle weights (M₁, M₂ ... Mₘ) associated for each axle index range, and converts the axle index into an axle weight.

The table differs according to the type of axle index (square-root of sum of squares of an acceleration, the maximum amplitude value of acceleration data, the maximum value of a spectrum amplitude obtained by performing frequency conversion on acceleration data), and thus tables that differ according to axle indexes are required.

The vehicle weight estimation unit 77 adds the axle weights of the respective axles and calculates the weight of the vehicle. Specifically, first, the vehicle weight estimation unit 77 obtains the axle weights of the respective axles from the conversion unit 76. Next, the vehicle weight estimation unit 77 adds the obtained axle weights, and calculates the vehicle weight.

In addition, in the above example, axle weights are obtained for respective axle indexes, and then the axle weights are added and a vehicle weight is calculated, but a configuration may also be adopted in which axle indexes are added, and an axle weight is then obtained using the added axle indexes.

The second index calculation unit 72 calculates a second index indicating the relation between the first index and the weight of the vehicle 30. Specifically, the second index calculation unit 72 first obtains axle weights from the vehicle weight estimation unit 71. Also, the second index calculation unit 72 obtains the first index from the first index calculation unit 12.

Next, the second index calculation unit 72 calculates a second index indicating the relation between a first index and an axle weight, using the first index and the axle weight. The second index may be a correlation coefficient indicating the relation between the sum of vibration levels and the axle weight, for example. Alternatively, the second index may be a correlation coefficient indicating the relation between the centroid of a spectrum density and an axle weight, for example.

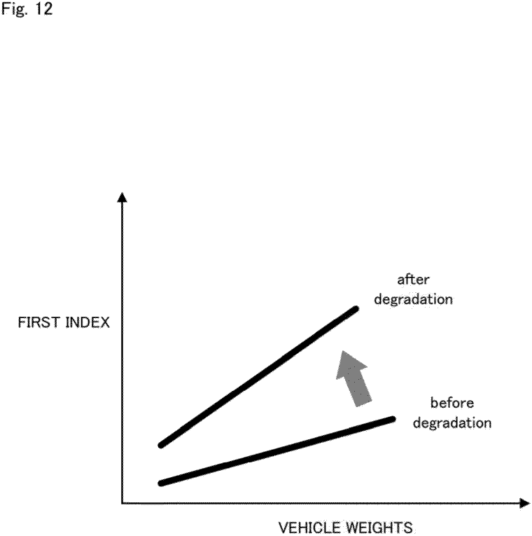

The estimation unit 73 estimates the presence or absence of an abnormality in accordance with a change in the second index. As shown in FIG. 12, as degradation of the expansion and contraction apparatus 23 proceeds, the inclination of the line becomes steeper, and thus the presence or absence of an abnormality in the expansion and contraction apparatus 23 is estimated based on this change. FIG. 12 is a diagram for describing the relation between a first index and the weight of a vehicle.

Specifically, the estimation unit 73 first obtains a second index from the second index calculation unit 72. Next, the estimation unit 73 calculates the difference between a second index estimated in a previous diagnosis and a second index estimated in a diagnosis performed after the previous diagnosis, which are stored in the storage unit. The difference between a second index estimated in a diagnosis three months ago and a second index estimated in the current diagnosis is calculated, for example.

Next, if the calculated difference is higher than or equal to a predetermined threshold value Th2, the estimation unit 73 estimates that there is an abnormality in the expansion and contraction apparatus 23. The estimation unit 73 then outputs the estimation result to the output information generation unit 18. The threshold value Th2 is determined through experiments, simulation, or the like.

The output information generation unit 18 generates output information for causing the output apparatus 26 to output an abnormality estimation result, and outputs the generated output information to the output apparatus 26. The output apparatus 26 then outputs abnormality estimation results corresponding to the measurement units 25 based on the output information. Note that, not only an abnormality estimation result, but also the waveform of the vibration response, the waveform of the frequency spectrum, the first index, the waveform of the axle response, the second index, and the axle weight may be displayed.

### Apparatus Operations

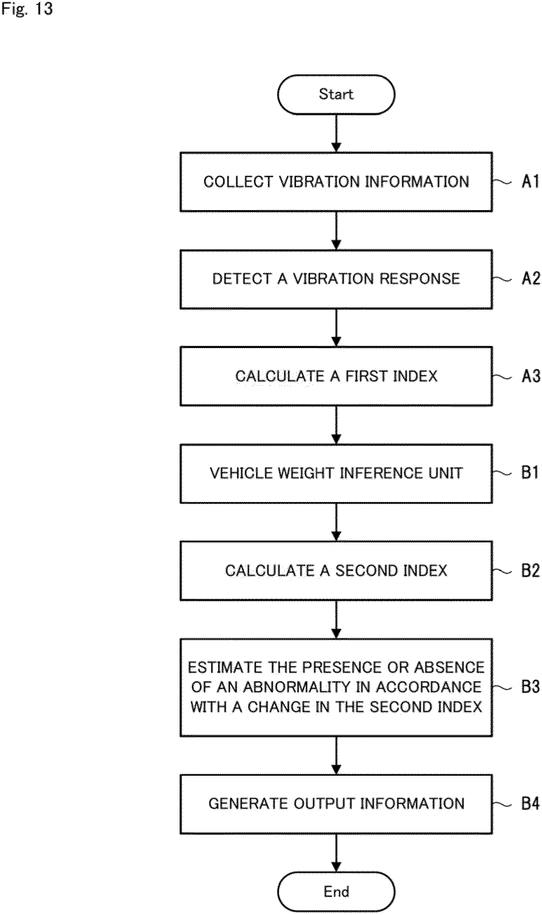

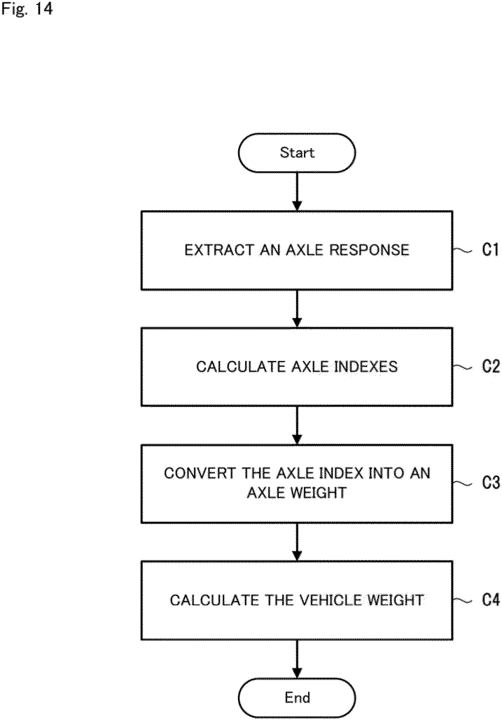

Next, operations of the abnormality estimation apparatus according to the second embodiment of the invention will be described with reference to FIGS. 13 and 14. FIG. 13 is a diagram for describing an exemplary operation of the abnormality estimation apparatus. FIG. 14 is a diagram for describing an example of a vehicle weight estimation operation. In the following description, FIGS. 1 to 12 will be referred to as appropriate. In addition, in the second embodiment, the abnormality estimation method is executed by causing the abnormality estimation apparatus to operate. Thus, description of the abnormality estimation method in the second embodiment is replaced with the following description of operations of the abnormality estimation apparatus.

First, processing of steps A1 to A3 shown in FIG. 13 is executed. However, the processing of steps A1 to A3 has been already described in the first example embodiment, and thus a detailed description is omitted.

Next, step B1 will be described with reference to FIG. 14.

As shown in FIG. 14, first, the axle response detection unit 74 detects an axle response that is produced when an axle of the vehicle 30 passes over the expansion and contraction apparatus 23, using vibration information (step C1).

Specifically, in step C1, first, the axle response detection unit 74 obtains vibration information from the collection unit 14. Next, in step C1, the axle response detection unit 74 extracts a response start time, a response end time, and a window width of an axle response. Detection of an axle response can be achieved using the above-describe axle response detection method (1) or (2), for example.

Next, the axle index calculation unit 75 calculates axle indexes of respective axles based on axle responses (step C2).

Specifically, in step C2, first, the axle index calculation unit 75 obtains axle responses of respective axles from the axle response detection unit 74. Next, in step C2, the axle index calculation unit 75 uses the acceleration data in each axle response to calculate the square-root of sum of squares of the acceleration data, the maximum amplitude value of the acceleration data, or the maximum value of a spectrum amplitude obtained by performing frequency conversion on the acceleration data. Next, in step C2, the axle index calculation unit 75 outputs an axle index calculated for each axle to the conversion unit 76.

Next, using the axle index, the conversion unit 76 refers to conversion information that indicates the correlation between an axle index and an axle weight and is stored in advance, and calculates an axle weight (step C3).

Specifically, in step C3, the conversion unit 76 first obtains the axle index calculated for each axle. Next, in step C3, the conversion unit 76 refers to the conversion information and converts the axle index into an axle weight, for each axle.

Next, the vehicle weight estimation unit 77 adds the axle weights of the respective axles, and calculates the weight of the vehicle (step C4).

Specifically, in step C4, first, the vehicle weight estimation unit 77 obtains the axle weights of the respective axles from the conversion unit 76. Next, in step C4, the vehicle weight estimation unit 77 adds the obtained axle weights, and calculates the vehicle weight.

In addition, in the above example, the axle weights are obtained for respective axle indexes, and then the axle weights are added and a vehicle weight is calculated, but a configuration may also be adopted in which axle indexes are added, and an axle weight is then obtained using the added axle indexes.

Next, once the above-described processing of step B1 in FIG. 13 (steps C1 to C4 in FIG. 14) has ended, in step B2 in FIG. 13, the second index calculation unit 72 then calculates a second index indicating the relation between the first index and the weight of the vehicle 30 (step B2).

Specifically, in step B2, first, the second index calculation unit 72 obtains the axle weights from the vehicle weight estimation unit 71. Also, the second index calculation unit 72 obtains the first index from the first index calculation unit 12.

Next, in step B2, the second index calculation unit 72 calculates a second index indicating the relation between the first index and the axle weight using the first index and the axle weight. The second index may be a correlation coefficient indicating the relation between the sum of vibration levels and the axle weight, or the like. Alternatively, the second index may be a correlation coefficient indicating the relation between the centroid of a spectrum density and the axle weight, or the like.

Next, the estimation unit 73 estimates the presence or absence of an abnormality in accordance with a change in the second index (step B3). As shown in FIG. 12, as degradation of the expansion and contraction apparatus 23 proceeds, the inclination of the line becomes steep, and thus the presence or absence of an abnormality in the expansion and contraction apparatus 23 is estimated based on this change.

Specifically, in step B3, the estimation unit 73 first obtains the second index from the second index calculation unit 72. Next, in step B3, the estimation unit 73 calculates the difference between a second index estimated in a previous diagnosis and a second index estimated in a diagnosis performed after the previous diagnosis, which are stored in the storage unit. The difference between a second index estimated in a diagnosis three months ago and a second index estimated in the current diagnosis is calculated, for example.

Next, in step B3, if the calculated difference is higher than or equal to the predetermined threshold value Th2, the estimation unit 73 estimates that there is an abnormality in the expansion and contraction apparatus 23. Then, in step B3, the estimation unit 73 outputs the estimation result to the output information generation unit 18. The threshold value Th2 is determined through experiments, simulation, or the like.

The output information generation unit 18 generates output information for causing the output apparatus 26 to output an abnormality estimation result, and outputs the generated output information to the output apparatus 26 (step B4). The output apparatus 26 then outputs abnormality estimation results respectively corresponding to the measurement units 25, based on the output information. Note that, not only an estimation result, but also the waveform of the vibration response, the waveform of the frequency spectrum, the first index, the waveform of the axle response, the second index, and the axle weight may be displayed.

Note that, in FIG. 13, after the processing of steps A1 to A3 is performed, the processing of step B1 is executed, but the processing of step B1 may be performed before the processing of steps A1 to A3 is performed. In addition, the processing of step B1 and the processing of steps A1 to A3 may be executed in parallel.

### Effects in Second Example Embodiment

As described above, according to the embodiment, a second index indicating the relation between a first index and the weight of the vehicle 30 is calculated using vibration that occurs in the bridge when the vehicle 30 passes over the expansion and contraction apparatus 23, the presence or absence of an abnormality is estimated in accordance with a change in the calculated second index, and the presence or absence of an abnormality in the expansion and contraction apparatus 23 is more accurately estimated.

In addition, it suffices that vibration that occurs in the bridge can be collected at a portion of the bridge, and thus it is possible to accurately estimate the presence or absence of an abnormality in the expansion and contraction apparatus, without imposing traffic lane regulations or the like.

Furthermore, it suffices that vibration that occurs in the bridge can be collected, and thus it is possible to accurately estimate the presence or absence of an abnormality in the expansion and contraction apparatus without performing any manual operation.

### Program

The program according to an embodiment of the invention may be a program that causes a computer to execute steps A1 to A3, and steps B1 to B4 shown in FIG. 13. By installing this program in a computer and executing the program, the abnormality estimation apparatus and the abnormality estimation method according to the example embodiment can be realized. In this case, the processor of the computer performs processing to function as the collection unit 14, the detection unit 11, the first index calculation unit 12 (the frequency conversion unit 15, the correction unit 16, the calculation unit 17), the vehicle weight estimation unit 71 (the axle response detection unit 74, the axle index calculation unit 75, the conversion unit 76, the vehicle weight estimation unit 77), the second index calculation unit 72, the estimation unit 73 and the output information generation unit 18.

Also, the program according to the embodiment may be executed by a computer system constructed by a plurality of computers. In this case, for example, each computer may function as any of the collection unit 14, the detection unit 11, the first index calculation unit 12 (the frequency conversion unit 15, the correction unit 16, the calculation unit 17), the vehicle weight estimation unit 71 (the axle response detection unit 74, the axle index calculation unit 75, the conversion unit 76, the vehicle weight estimation unit 77), the second index calculation unit 72, the estimation unit 73 and the output information generation unit 18.

### Physical Configuration

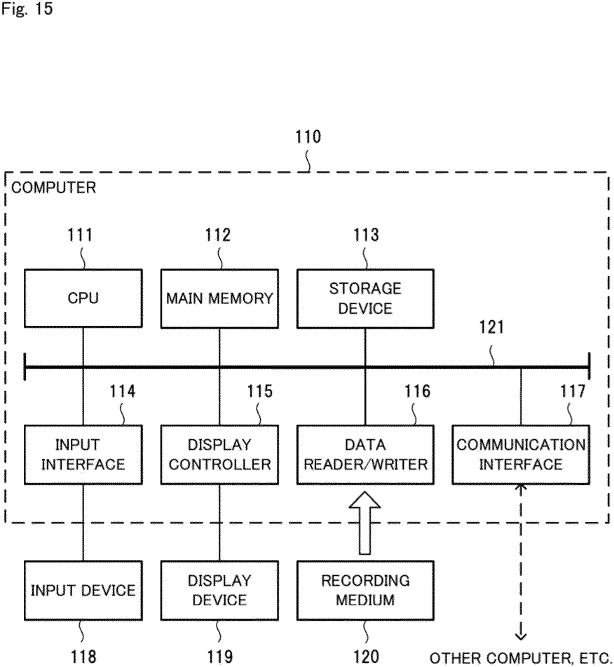

Here, a computer that realizes an abnormality estimation apparatus by executing the program according to an example embodiment 1 and 2 will be described with reference to FIG. 15. FIG. 15 is a block diagram showing an example of a computer that realizes the abnormality estimation apparatus according to an example embodiment 1 and 2 of the invention.

As shown in FIG. 15, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the abnormality estimation apparatus 10 according to this example embodiment can also be realized by using hardware corresponding to each unit. Furthermore, a portion of the abnormality estimation apparatus 10 may be realized by a program, and the remaining portion realized by hardware.

### Supplementary Notes

Furthermore, the following supplementary notes are disclosed regarding the example embodiments described above. Some portion or all of the example embodiments described above can be realized according to (supplementary note 1) to (supplementary note 18) described below, but the below description does not limit the invention.

### Supplementary Note 1

An abnormality estimation apparatus comprising:
a detection unit configured to detect a vibration response when a vehicle passes over an expansion and contraction apparatus, using vibration information indicating vibration that occurs in a bridge;
a first index calculation unit configured to calculate a first index for determining the presence or absence of an abnormality in the expansion and contraction apparatus, using the vibration response; and
an estimation unit configured to estimate the presence or absence of an abnormality in accordance with a change in the first index.

### Supplementary Note 2

The abnormality estimation apparatus according to supplementary note 1, wherein one of or both the sum of vibration levels corresponding to the vibration response and a centroid of a frequency spectrum density are used as the first index.

### Supplementary Note 3

The abnormality estimation apparatus according to supplementary note 1 or 2, further comprising a correction unit configured to correct the vibration response in accordance with a position of a sensor that measures the vibration that occurs in the bridge.

### Supplementary Note 4

An abnormality estimation apparatus comprising:
a detection configured to detect a vibration response when a vehicle passes over an expansion and contraction apparatus, using vibration information indicating vibration that occurs in a bridge;
a first index calculation configured to calculate a first index for determining the presence or absence of an abnormality in the expansion and contraction apparatus, using the vibration response;
a vehicle weight estimation configured to estimate a weight of the vehicle;
a second index calculation configured to calculate a second index indicating a relation between the first index and the weight of the vehicle; and
an estimation configured to estimate the presence or absence of an abnormality in accordance with a change in the second index.

### Supplementary Note 5

The abnormality estimation apparatus according to supplementary note 4, wherein one of or both the sum of vibration levels corresponding to the vibration response and a centroid of a frequency spectrum density are used as the first index.

### Supplementary Note 6

The abnormality estimation apparatus according to supplementary note 4 or 5, further comprising a correction configured to correct the vibration response in accordance with a position of a sensor that measures the vibration that occurs in the bridge.

### Supplementary Note 7

An abnormality estimation method comprising:
a detection step of detecting a vibration response when a vehicle passes over an expansion and contraction apparatus, using vibration information indicating vibration that occurs in a bridge;
a first index calculation step of calculating a first index for determining the presence or absence of an abnormality in the expansion and contraction apparatus, using the vibration response; and
an estimation step of estimating the presence or absence of an abnormality in accordance with a change in the first index.

### Supplementary Note 8

The abnormality estimation method according to supplementary note 7, wherein one of or both the sum of vibration levels corresponding to the vibration response and a centroid of a frequency spectrum density are used as the first index.

### Supplementary Note 9

The abnormality estimation method according to supplementary note 7 or 8, further comprising a correction step of correcting the vibration response in accordance with a position of a sensor that measures the vibration that occurs in the bridge.

### Supplementary Note 10

An abnormality estimation method comprising:
a detection step of detecting a vibration response when a vehicle passes over an expansion and contraction apparatus, using vibration information indicating vibration that occurs in a bridge;
a first index calculation step of calculating a first index for determining the presence or absence of an abnormality in the expansion and contraction apparatus, using the vibration response;
a vehicle weight estimation step of estimating a weight of the vehicle;
a second index calculation step of calculating a second index indicating the relation between the first index and the weight of the vehicle; and
an estimation step of estimating the presence or absence of an abnormality in accordance with a change in the second index.

### Supplementary Note 11

The abnormality estimation method according to supplementary note 10, wherein one of or both the sum of vibration levels corresponding to the vibration response and a centroid of a frequency spectrum density are used as the first index.

### Supplementary Note 12

The abnormality estimation method according to supplementary note 10 or 11, further comprising a correction step of correcting the vibration response in accordance with a position of a sensor that measures the vibration that occurs in the bridge.

### Supplementary Note 13

A computer-readable recording medium that includes a program recorded thereon, the program including instructions that cause a computer to:
a detection step of detecting a vibration response when a vehicle passes over an expansion and contraction apparatus, using vibration information indicating vibration that occurs in a bridge;
a first index calculation step of calculating a first index for determining the presence or absence of an abnormality in the expansion and contraction apparatus, using the vibration response; and
an estimation step of estimating the presence or absence of an abnormality in accordance with a change in the first index.

### Supplementary Note 14

The computer-readable recording medium according to supplementary note 13, wherein one of or both the sum of vibration levels corresponding to the vibration response and a centroid of a frequency spectrum density are used as the first index.

### Supplementary Note 15

The computer-readable recording medium according to supplementary note 13 or 14 that includes a program recorded thereon, the program further including instructions that cause a computer to a correction step of correcting the vibration response in accordance with a position of a sensor that measures the vibration that occurs in the bridge.

### Supplementary Note 16

A computer-readable recording medium that includes a program recorded thereon, the program including instructions that cause a computer to:
a detection step of detecting a vibration response when a vehicle passes over an expansion and contraction apparatus, using vibration information indicating vibration that occurs in a bridge;
a first index calculation step of calculating a first index for determining the presence or absence of an abnormality in the expansion and contraction apparatus, using the vibration response;
a vehicle weight estimation step of estimating the weight of the vehicle;
a second index calculation step of calculating a second index indicating the relation between the first index and the weight of the vehicle; and
an estimation step of estimating the presence or absence of an abnormality in accordance with a change in the second index.

### Supplementary Note 17

The computer-readable recording medium according to supplementary note 16, wherein one of or both the sum of vibration levels corresponding to the vibration response and a centroid of a frequency spectrum density are used as the first index.

### Supplementary Note 18

The computer-readable recording medium according to supplementary note 16 or 17 that includes a program recorded thereon, the program further including instructions that cause a computer to a correction step of correcting the vibration response in accordance with a position of a sensor that measures the vibration that occurs in the bridge.

Although the invention of this application has been described with reference to exemplary embodiments, the invention of this application is not limited to the above exemplary embodiments. Within the scope of the invention of this application, various changes that can be understood by those skilled in the art can be made to the configuration and details of the invention of this application.

### INDUSTRIAL APPLICABILITY

As described above, according to the invention, it is possible to improve the accuracy for estimating the presence and absence of an abnormality in an expansion and contraction apparatus. The invention is useful in fields where it is necessary to estimate the presence and absence of an abnormality in an expansion and contraction apparatus.

### LIST OF REFERENCE SIGNS

10, 70 Abnormality estimation apparatus
11 Detection unit
12 First index calculation unit
13, 73 Estimation unit
14 Collection unit
15 Frequency conversion unit
16 Correction unit
17 Calculation unit
18 Output information generation unit
21 Upper structure
22 Lower structure
23 Expansion and contraction apparatus
24 Bearing part
25 Measurement unit
26 Output apparatus
30 Vehicle
71 Vehicle weight estimation unit
72 Second index calculation unit
74 Axle response detection unit
75 Axle index calculation unit
76 Conversion unit
77 Vehicle weight estimation unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An abnormality estimation apparatus comprising:
a detection unit configured to detect a vibration response when a vehicle passes over an expansion and contraction apparatus, using vibration information indicating vibration that occurs in a bridge;
a first index calculation unit configured to calculate a first index for determining the presence or absence of an abnormality in the expansion and contraction apparatus, using the vibration response; and
an estimation unit configured to estimate the presence or absence of an abnormality in accordance with a change in the first index.

2. The abnormality estimation apparatus according to claim 1,
wherein one of or both the sum of vibration levels corresponding to the vibration response and a centroid of a frequency spectrum density are used as the first index.

3. The abnormality estimation apparatus according to claim 1, further comprising
a correction unit configured to correct the vibration response in accordance with a position of a sensor that measures the vibration that occurs in the bridge.

4-6. (canceled)

7. An abnormality estimation method comprising:
detecting a vibration response when a vehicle passes over an expansion and contraction apparatus, using vibration information indicating vibration that occurs in a bridge;
calculating a first index for determining the presence or absence of an abnormality in the expansion and contraction apparatus, using the vibration response; and
estimating the presence or absence of an abnormality in accordance with a change in the first index.

8-12. (canceled)

13. A non-transitory computer-readable recording medium that includes a program recorded thereon, the program including instructions that cause a computer to:
detect a vibration response when a vehicle passes over an expansion and contraction apparatus, using vibration information indicating vibration that occurs in a bridge;
calculate a first index for determining the presence or absence of an abnormality in the expansion and contraction apparatus, using the vibration response; and
estimate the presence or absence of an abnormality in accordance with a change in the first index.

14-18. (canceled)
